(19) United States
(12) Patent Application Publication
(10) Pub. No.: US 2010/0099389 A1
(43) Pub. Date: Apr. 22, 2010

(54) Methods, Presence Server, User Equipment (UE), and Presence Message for User Identity Update

(75) Inventors: Zhongwen Zhu, Saint-Laurent (CA); Edoardo Gavita, Laval (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/256,124

(22) Filed: Oct. 22, 2008

(51) Int. Cl. H04M 3/42

(52) U.S. Cl. 455/414.1

(57) ABSTRACT

There are provided methods, a presence server, a User Equipment (UE), and a presence message in the form of a computer data signal embodied in a transmission medium for notifying about a second identity assignment to the UE. The second user identity is obtained from a network and stored. The first identity may be an MSISDN assigned by a first network, while the second identity may comprise another MSISDN and/or a SIP URI assigned by another network, e.g. by an IMS network for use in obtaining IMS services. Then, a presence message (e.g. a SIP SUBSCRIBE or NOTIFY message) is sent out to notify at least one other user about the assignment of the second user identity, the presence message comprising the first and second identities of the UE, so that communications can be initiated by the other user using the second identity.

### TECHNICAL FIELD

The present invention relates to the area of service provision and user identity assignment.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally, cellular phones and Wi-Fi have added a mobile element to communications.

To accommodate the new and different ways in which IP networks are being used to provide various services, new network architectures are being developed and standardized. IP Multimedia Subsystem (IMS) is an architectural framework utilized for delivering IP multimedia services to end users. The IMS architecture has evolved into a service-independent topology which uses IP protocols, e.g., Session Initiation Protocol (SIP) signalling, to provide a convergence mechanism for disparate systems. In part, this is accomplished via the provision of a horizontal control layer which isolates the access network from the service layer. Among other things, the IMS architecture provides a useful platform for the rollout of services such as for example IPTV (IP Television), including live TV and Video-on-Demand, IM (Instant Messaging) systems and services, mobile gaming, etc.

According to the 3GPP (3^{rd} generation Partnership Project) standards organization, multimedia services deployed in IMS networks can be used by IMS users who subscribe to that network. For example, a public service identity (PSI), i.e., one type of SIP uniform resource identifier (URI), enables an IMS user to locate a service within its own IMS network. The PSI is either pre-configured at the terminal, or downloaded from the provisioning node in the IMS network.

Because it is rather expensive to implement IMS service solutions in a network, not all network operators have currently operative IMS servicing and, as a consequence, not all subscribers can be provided IMS service. For example, a subscriber of a network operator implementing IMS can be provided IPTV services, instant messaging, and other services based on the network's architectures, while other subscribers of a different network, can only have access, for example, to basic voice call servicing and SMS. The 3GPP is therefore looking into solutions on how to provide the subscriber of a non-IMS network with limited IMS service from another network operator that implements IMS. However, it is not yet clear how such a subscription, maybe only partial, can take place. It is anticipated that the non-IMS subscriber might have to subscribe with the IMS network, which, for example, overlaps the radio coverage of the subscribers' home non-IMS network, in order to get access to IMS services. However, in such instances, it is anticipated that the non-IMS subscriber will have to obtain a new user identity associated with the IMS network. The subscriber will have to use the new identity for having access to IMS services, along with the older identity to carry out basic service (e.g. voice call and SMS) in his original network.

However, such a scenario can create a problem associated with the assignment of two user identities to the same user. Indeed, the same subscriber's user equipment (UE) will be assigned two identities to be used for different services in different networks. In many instances, that subscriber who already has been assigned an MSISDN (Mobile Station International Subscriber Directory Number, or phone number) by its original network is further assigned a second MSISDN and a SIP URI from the IMS network. A problem arises for the corresponding contacts of the subscriber who do not know which one of the user's identities, i.e. which one of the first MSISDN, the second MSISDN, or the SIP URI should be used, and in which circumstances, for communicating with him/her.

In order to better illustrate the problem associated with the prior art implementations, reference is now made to FIG. 1 (Prior-Art) that shows a high-level network diagram illustrating the problematic associated with the prior-art implementation where a user communicates with other IMS users. Shown in FIG. 1 is a telecommunications network 10 comprising a first IMS operator's network 12 and a second non-IMS operator's network 14. Users A, C, and D using respectively UEs 13, 15, and 17, are IMS users associated with the IMS operator's network 12. Likewise, a non-IMS user B uses a UE 18 associated with the non-IMS network 14. User B has been assigned by the non-IMS network 14 a first user identity 19 in the form of, e.g. the MSISDN +1-514-333-3333. The subscription of the user B may be stored in the HLR (Home Location Register) or AAA (Authorisation, Authentication and Accounting server) 16 of the network 14. It is also assumed for the sake of the present exemplary scenario that user B typically communicates, e.g. on a regular basis, with users A, C, and D using voice communications and other basic service provided by both the networks 12 and 14, which are connected via a NNI (Network-to-Network Interface) 13. User B gets access 15 to the network 14 in order to be provided basic communication services by that network.

At a given point in time, user B desires to get also IMS service and, for this purpose, since his own home network 14 does not support IMS, he starts subscribing, action 23, to the IMS service offered by the operator A's network 12, which substantially overlaps in terms of radio coverage the network 14. For so doing, after an initial registration and authentication of the user B by the network 12, an IMS client can be downloaded and installed on the UE 18 of the user B in order to support the provision of IMS service(s) for the user B. The operator A's network 12 accepts the subscription from user B after e.g. user's personal information and proper charging information is provided, and stores the subscription information in the Home Subscriber Server (HSS) 20. The subscription information includes a new user identity 21, such as for example a new MSISDN and a new SIP URI assigned to user B for use in getting IMS service from the network 12. The provisioning server 22 sends the new identity 21 to the user B's UE 18, which stores it along with the original one. At that time, the user B's UE 18 is not only assigned a first user identity 19 (the MSISDN +1-514-333-3333) by the network 14 but also IMS network 12's identities 21 in the form of a new MSISDN and of a new SIP URI. Such a situation can create some confusion for the users A, C and D who know user B only by its original MSISDN identity (+1-514-333-3333) and therefore cannot communicate with the user B using enhanced IMS services (e.g. IM, chat, video calls). This deprives the network operator A of additional revenues, as users A, C and D cannot initiate value added IMS-based services such as video calls, instant messaging or chat with user B.

Although there is no solution as the one proposed by the present invention, the patent application publication number US2008/0102802 A1 bears some relationship with the field of the present invention. In this publication, there is disclosed a presence information delivery apparatus and method for mobile communication. In this publication, a presence information delivery apparatus uses an SMS scheme in order to exchange information regarding presence. Presence information is transmitted to at least one member of a predetermined group using SMS. The advantage of this scheme is that users can share their presence information with other members of a specific group without engagement or an additional server for presence.

Accordingly, it should be readily appreciated that in order to overcome the deficiencies and shortcomings of the existing solutions, it would be advantageous to have a solution allowing for improved IMS-based communications between users of an IMS network and a newly registered IMS subscriber.

### SUMMARY

In one aspect, the present invention is a method for notifying about a second user identity assignment to a User Equipment (UE) having already a first identity, the method comprising the steps of obtaining the second user identity from a network; storing the second user identity in the UE; and sending out a presence message to notify at least one other user about the second user identity, the presence message comprising the first and second identities of the UE.

In another aspect, the present invention is a UE comprising a first memory storing a first identity of the UE; a second memory adapted to store a second identity assigned to the UE; and a SIP (Session Initiation Protocol) module that communicates with a network to obtain the second identity, wherein when the second identity is assigned to the UE it is stored in the second memory, and wherein the SIP module sends out a presence message to notify at least one other user about the second identity, the presence message comprising the first and second identities of the UE.

In yet another aspect, the present invention is a method for notifying about an assignment of a second identity to a first UE having already a first identity, the method comprising the steps of receiving a presence message destined to a second UE, the message comprising the first identity of the first UE and the second identity of the first UE; and responsive to the presence message, sending out a presence notification to the second UE, the presence notification comprising the first identity of the first UE and the second identity of the first UE.

In yet another aspect, the present invention is a presence server, comprising a presence service logic module that includes a SIP module that receives a presence message destined to a second UE, the message comprising a first identity of a first UE and a second identity of the first UE, and responsive to the presence message, the SIP module sending out a presence notification to the second UE, the presence notification comprising the first identity of the first UE and the second identity of the first UE.

In yet another aspect, the present invention is a presence message in the form of a computer data signal embodied in a transmission medium, comprising a segment including a first identity of a first UE (User Equipment); and another segment including a second identity of the first UE, wherein the presence message is sent out to notify at least one second UE of an assignment of the second identity to the first UE.

### DRAWINGS

For a more detailed understanding of the invention, for further objects and advantages thereof, reference can now be made to the following description, taken in conjunction with the accompanying drawings, in which:

FIG. 1 (Prior-Art), is a high-level network diagram illustrating the problematic associated with a prior-art implementation where a user communicates with other IMS users;

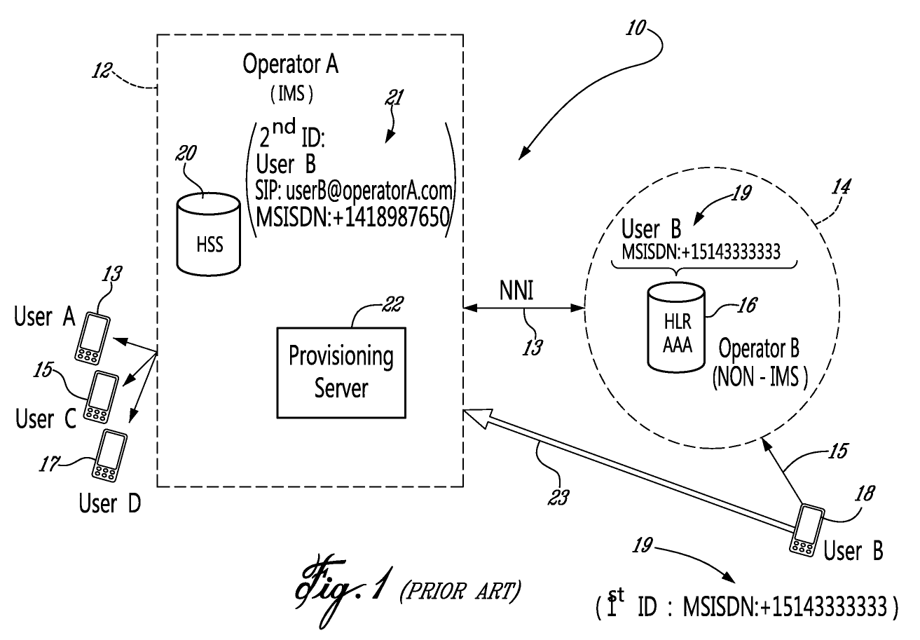

FIG. 2 is a high level network diagram illustrative of an exemplary preferred embodiment of the present invention;

FIG. 3 is a flow chart diagram illustrative of another exemplary preferred embodiment of the present invention;

FIG. 4 is a block diagram of a user equipment implementing an exemplary preferred embodiment of the present invention;

FIG. 5 is another flow chart diagram representative of an exemplary preferred embodiment of present invention;

FIG. 6 is a high level block diagram of a present server implementing an exemplary preferred embodiment of the present invention; and

FIG. 7 is a high-level diagram of a presence message according to the preferred embodiment of the invention.

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention proposes to use a modified Open Mobile Alliance (OMA) architecture in order to transfer new identities assigned to a subscriber, e.g. by an IMS network, towards one or more users who may want to communicate with the subscriber using the new identities. According to the invention, for example, first a non-IMS user originally served by a non-IMS network decides to subscribe to IMS service with another IMS network, and obtains from the IMS network new identities (e.g. a new MSISDN and a new SIP URI) for getting IMS services. Following the assignment of the new IMS network's identities to a user (also called herein a subscriber), the latter initiates a presence notification towards one or more friends or contacts, in order to notify them about his new subscription to IMS services provided by the IMS network. Via this presence notification, contacts can be, for example, notified of the new identities, therefore allowing them to initiate IMS-based communications with the newly subscribed user. According to the invention, the user uploads its new user identities assigned by the IMS network to a presence service, which propagates the new user identities to contacts (one or more contacts specified by the user B). A presence notification is delivered towards the one or more contacts from the present service, wherein the presence notification comprises both the original user identity and the new IMS identities (also called herein user credentials). Being provided with new user credentials for IMS, the contacts can use this new credentials in order to initiate IMS services with the user, such as for example video conferencing, instant messaging, chat, etc.

According to one aspect of the preferred embodiment of the invention, the presence notification may be part of a presence subscription from the subscriber being assigned the new IMS identity to other IMS users. For example, while subscribing to get presence information from another IMS user, the subscriber can also notify that user of his new credentials.

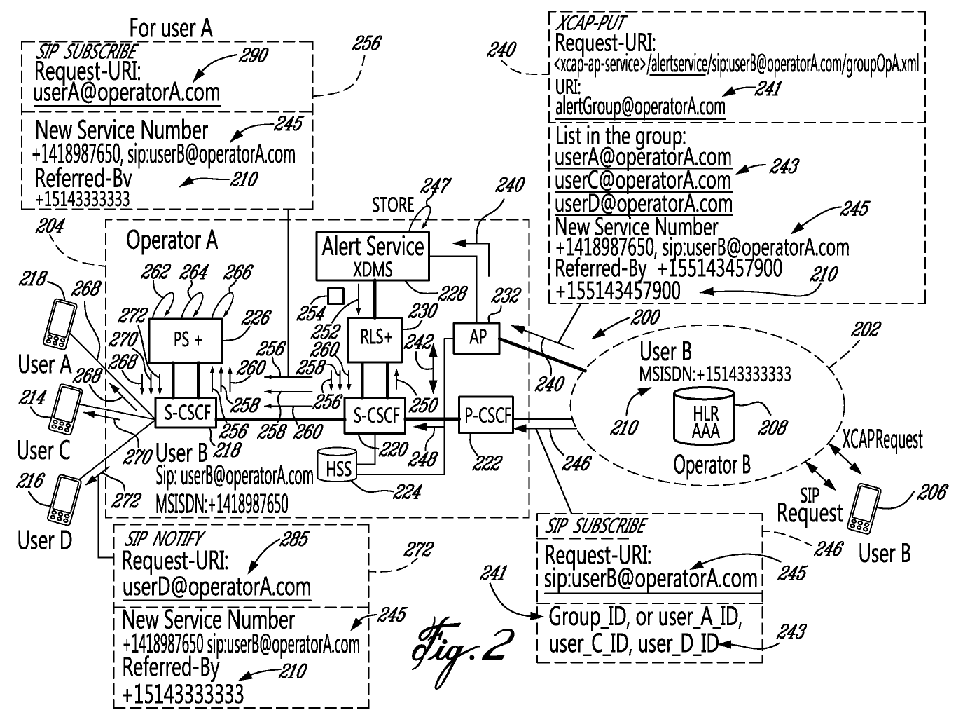

Reference is now made to FIG. 2, which is a high level network diagram illustrative of an exemplary preferred embodiment of the invention. Shown in FIG. 2 is, first, a simplified view of a non-IMS network 202 belonging to operator B. Connected to network 202 is a user equipment (UE) B 206, which is provided non-IMS service (such as for example Voice, SMS, MMS) by the network 202. The UE 206 is assigned a first user identity 210 in the form of an MSISDN (e.g. +1 514-333-3333) in the operator B's network 202. The first user identity 210 is stored in a home location register (HLR), or in an authorization, authentication, and accounting server (AAA) 208. Connected to the non-IMS network 202 is an IMS network 204 of the operator A of which only a simplified view is shown. The networks 202 and 204 are, according to the present exemplary preferred embodiment of the invention, preferably substantially overlapping in terms of radio coverage, i.e. for example in such a way that UE 206 can receive network coverage not only from network 202, but also from the operator A′ network 204. The IMS network 204 comprises call state control functions (CSCFs) 218, 220, and 222, responsible for handling and controlling IMS service communications for the registered users. The network 204 further comprises a presence server (PS) 226 that handles presence services according to, for example, the Open Mobile Alliance (OMA) Technical Specification Presence-SIMPLE V1, published on Nov. 28, 2006, and which is herein included by reference in its entirety (and that can be found at http://www.openmobilealliance.org/Technical/release-program/docs/PresenceSIMPLE/V1_{—}0_{—}1-20061128-H/OMA-TS-Presence_SIMPLE-V1_{—}0_{—}1-20061128-H.pdt). Furthermore, the network 204 is also provided with an aggregation proxy (AP) 232, which functions to perform security procedures, as well as to request traffic forwarding procedures, e.g. for HTTP traffic. Security procedures comprise authentication & XDM Client ID assertion. The HTTP forwarding functionality consists of XCAP request forwarding request such as XCAP server capabilities retrieval and XCAP directory retrieval. In addition, the AP supports data compression encoding schemes. The functioning of an exemplary AP is fully described in the OMA's technical Specification XDM Core V1 published on Nov. 28, 2006, which is herein included by reference in its entirety, and which can be found at (http://www.openmobilealliance.org/technical/release_program/docs/XDM/V1_{—}0_{—}1-20061128-A/OMA-TS-XDM_Core-V1_{—}0_{—}1-20061128-A.pdt). Finally, the network 204 comprises an RLS node 230 and an alert service XDMS 228 which function is to store a list of users (e.g., UEs A,C, D) that may send invitations to UE B 206 and also store UE B identities (i.e., MSISDN and SIP URI) as well as UE 206 old identity, in a manner that is yet to be described. A home subscriber server (HSS) 224 stores subscriber information related to credentials, authorization, and services for the subscribers registered with the network 204. Connected to this network are exemplary users A, C and D utilizing UEs 212, 214, and 216 respectively, although it is understood that many more users can be connected to the network 204.

Originally, user B is a subscriber of the operators B's network 202 where he is assigned a first identity in the form of the MSISDN 210, stored in the HLR/AAA server 208, and where he receives basic communication service, comprising for example basic services alike voice communications and SMS. At one point, user B decides to subscribe to the IMS service provided by the operator A′ IMS network 204 and, following an access and registration sequence (not shown) with the network 204, user B's UE 206 is assigned a second identity 245, e.g. a set of new IMS credentials, such as for example a new MSISDN, and a new SIP URI (e.g. userB@OperatorA.com). Using this second identity, also called herein new user credentials, IMS service can be provided by the network 204 to the user B (it is assumed that either user B's UE 206 is already capable, or configured to, for carrying out IMS communications, or, alternatively that during the registration sequence with the network 204, a proper IMS client is downloaded from the Operator A's network to the UE 206, thus enabling the UE to carry out IMS based communications).

Once the UE 206 is assigned the new credentials, user B may send a message 240 from the UE 206 to the aggregation proxy 232 located in the operator A's network 204, wherein the message includes a list of one or more persons that have to be notified of the new credentials of the user B, the new credentials 245 of UE 206 including the new MSISDN and SIP URI, and the original MSISDN 210 of user B. The message 240 may take the form of an XCAP PUT message according to, for example, the IETF's RFC 4825 as published on Sep. 16, 2008, which is herein included in its entirety by reference, and which can be found at http://www.ietf.org/rfc/rfc4825.txt. The XCAP PUT message can also be defined according to section 6.1 of the OMA's Technical Specification XDM V2, as published on Sep. 16, 2008, and which is herein included in its entirety by reference, and which can be found at http://www.openmobilealliance.org/technical/release_program/docs/XDM/V2_{—}0-20080916-C/OMA-TS-XDM_Core-V2_{—}0-20080916-c.pdf. The message 240 is better shown in the dotted lines of FIG. 2 and may comprise, for example, a group list URI 241 that refers to the users who should be notified of the new credentials of user B, and/or the individual user identities 243 identifying, for example, individually the user A, C, and D who have to be notified of the new credentials. The message 240 further may comprise the identity 210 assigned to the UE 206 by the network 202. Upon receipt of message 240, the aggregation proxy 232 authenticates user B with the HSS 224 and upon positive authentication, forwards the message towards an alert service 228, which functions to receive the aforementioned message 240, verify the contents of the message and finally store them in its internal XDMS database. By storing these new message credentials for User B, the Alert Service 228 facilitates any requesting function (e.g. the RLS 230) to make a correlation between User B's old and new identities. The alert service 228 stores the identities of the group 241 and the individual identities 243, 245, and 210 received in the message 240, action 247, and returns a confirmation of the receipt of message 240 to the UE 206 (confirmation not shown for simplicity purposes in FIG. 2). At this point, user B 206 sends out a presence message 246 to notify at least one other user about the second user identity and to subscribe to presence information of this at least one other user. The presence message 246 may take the form of a SIP SUBSCRIBE request 246 sent out from the UE 206 in order to subscribe to presence information of his contact(s). The SIP SUBSCRIBE request 246 is also used to notify these contacts of his new credentials 245 in the IMS network 204. The message 246, shown in more details within the dotted lines in FIG. 2, may comprise the identities 245 of the user B in the operator A's network 204 along with the identity of the group of users 241 to be notified and/or the individual identities 243 taken individually of the users A, C, and D that have to be notified of the new credentials of the UE 206 in the network 204. The SIP SUBSCRIBE message 246 is received by the proxy CSCF 222 of the network 204 and relayed further to the serving CSCF 220 in action 248, from where the message is further relayed in action 250 to the RLS server 230 as triggered, for example, by internal filter criteria defined to route incoming SIP SUBSCRIBE messages to the RLS. The RLS 230 may fetch the individual identities of persons to be alerted about the new credentials of user B from the alert service 238 in case the SIP SUBSCRIBE message 246 only includes the group identifier 241. In this case, the RLS needs to consult the alert service XDMS 228 in order to obtain in action 252 the list 254 of the individual users to be notified, e.g. the individual identities of users A, C, and D. Based on these individual identities of the users, in actions 256, 258, and 260, shown as substantially concomitant in FIG. 2, the RLS issues individual SIP SUBSCRIBE messages directed in the present exemplary scenario to the three users A, C, and D that have to be notified about the new credentials of the user B 206, with the purpose of notifying these users of the new credentials of user B. Each such message includes the new identities 245 of the user B, such as for example the newly assigned MSISDN, and SIP URI for use in the IMS network 204, along with the original MSISDN 210 of user B assigned by the operator B network 202. An exemplary message 256 destined to user A is shown in greater details in dotted lines in FIG. 2 and includes also the identity 290 of the destination user A.

In the alternate case wherein the message 246 comprised the individual identities of the users A, C, and D to be notified about the new credentials of user B, the actions of inquiring by the RLS with the alert service 228 can be skipped, as the RLS server 230 is already provided, from the message 250, with the individual identities of the users A, C, and D. In this case too, the RLS issues individual SIP SUBSCRIBE messages directed to the three users A, C, and D who have to be notified about the new credentials of the user B 206, as mentioned hereinbefore.

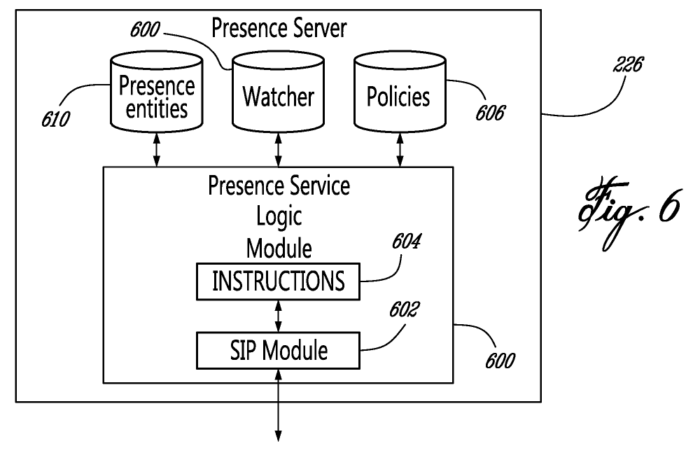

The S-CSCF 220 receives the three SIP SUBSCRIBE messages 256, 258, and 260 and further relays them to the S-CSCF 218 that serves the users A, C, and D. The S-CSCF 218, upon receipt of messages 256, 258, and 260 forwards them to the presence server 226 based upon the request URI found in the messages. Reference is now made jointly to FIG. 2, previously described, and to FIG. 6 which shows a high level block diagram of the presence server 226. The presence server 226 is provisioned with a presence server logic module 600 that functions to provide the functionalities related to the presence service to external entities, including to UEs and other server. For this purpose, the presence service logic module 600 is provisioned with a SIP module 602 which is responsible for handling SIP-based communications with external entities, such as for example with the S-CSCF 218 and other UEs. Furthermore, the presence service logic module 600 is provisioned with instructions that when executed instruct the SIP module 602 to analyze, construct or handle the SIP-based communications in order to provide the requested presence services. The presence service logic module 600 is in communication with three databases or data storages. A first database 606 stores presence policies associated for example with event and/or conditions that define the circumstances in which to provide presence information to specific entities (also called watchers). A second database 608 comprises a list of watchers that subscribed to presence information of other entities. Finally, a third database 610 comprises a list of presence entities, also called presentities, which are the entities which presence is being monitored by the watchers. Upon receipt of the SUBSCRIBE messages 256, 258, and 260 by the presence server 226 the later, via its SIP module 602, analyzes the messages and interprets them as a trigger in order to issue notifications towards the subscribers mentioned in these messages, i.e. towards the users A. C, and D.

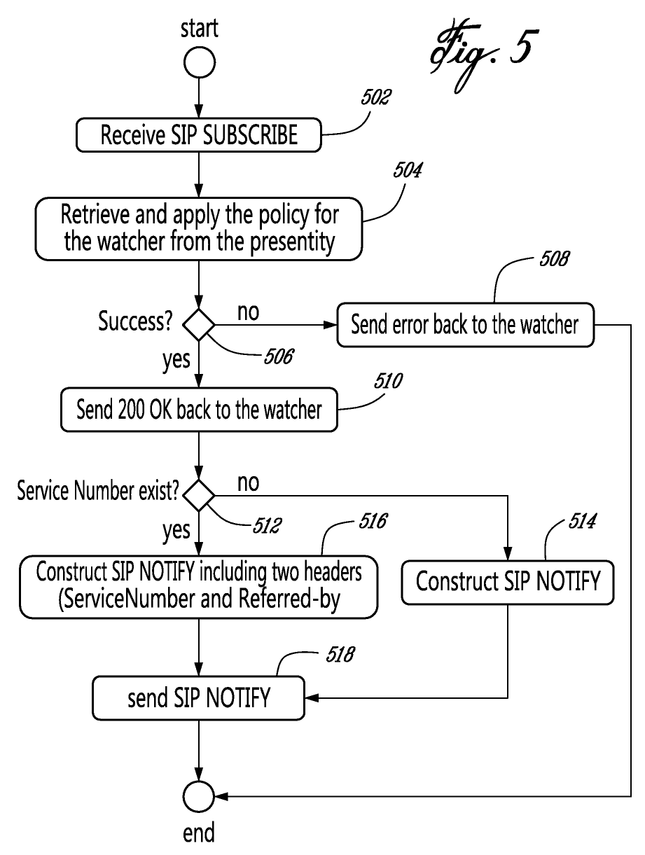

Reference is now made jointly to FIG. 2 and FIG. 6, previously described, and further to FIG. 5 which shows a high level flow chart diagram illustrative of an exemplary embodiment descriptive of the manner in which the presence server generates the notifications towards the subscribers A, C, and D. The method shows steps that can be performed, for example, by the SIP module 602 of the presence server logic module 600, under instructions from the instructions module 604. The method may start in action 502 where the SIP module 602 of the presence server 226 receives the SIP SUBSCRIBE messages 256, 258, or 260 (also called the presence messages). The following is described in relation to the SIP SUBSCRIBE message 256 only, for simplicity purposes, although it is understood that an analogous treatment is also applied to messages 258 and 260. The SIP module 602, under the instructions received from the module 604, retrieves and applies the policy for the watcher, i.e. for user B's UE 206 for the presentity by consulting databases 606, 608, and 610. If the retrieval and the application of the policies is successful as determined in action 506, the SIP module 602 send a 200 OK message back to the watcher, i.e. to the user B's UE 206, action 510. Otherwise, if the retrieval of the policies in action 506 is unsuccessful, an error message is sent in action 508 to the watcher. In action 512, the SIP module 602 determines if the service number exists, i.e. if the user B's UE new credentials (MSISDN or SIP URI) 245 exist. If the service number does not exist, then in action 514 the SIP module 602 constructs a new SIP NOTIFY message to be sent to e.g. user A's UE 218 to ask permission for user B to watch User A's presence, and sends it out in action 518. Otherwise, if it is determined in action 512 that the user B's UE 206 new credentials exist, in action 516 the SIP module 602 constructs a SIP NOTIFY message including the two headers related to the user B, i.e. including both the original user B′ identity 210 in the operator B′ network 202, and the newly assigned credential 245 by the operator A network 204. In action 518, a SIP NOTIFY message is thus issued.

Reference now being made back to FIG. 2 wherein the SIP NOTIFY messages 268, 270, and 272 respectively are constructed as described hereinbefore, and sent from the presence server 226 to users A, C, and D, in order to notify these users of the new IMS credentials of user B's UE 206. The exemplary form of anyone of the message 268, 270, or 272 is illustrated in dotted lines in FIG. 2, for example, with particular respect to the message 272 addressed to user D 216. The message can take the form of a SIP NOTIFY message that includes a destination address 285 that is userD@OperatorA.com, along with the new IMS credentials 245 of the user B's UE 206 and the older identity 210 of the user B 206. Having being sent the notifications 268, 270, and 272, the IMS users A, C, and D are informed of the IMS credentials 245 of the user B so that from this moment on, they can also initiate IMS-based communication services with user B 206.

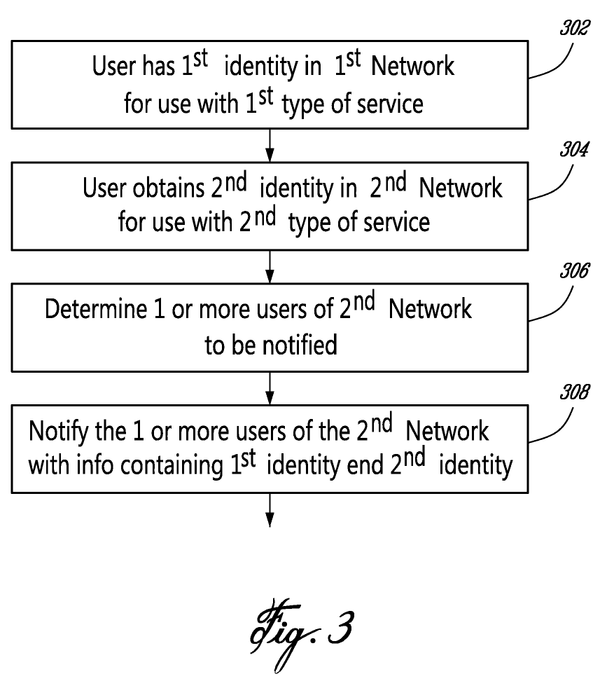

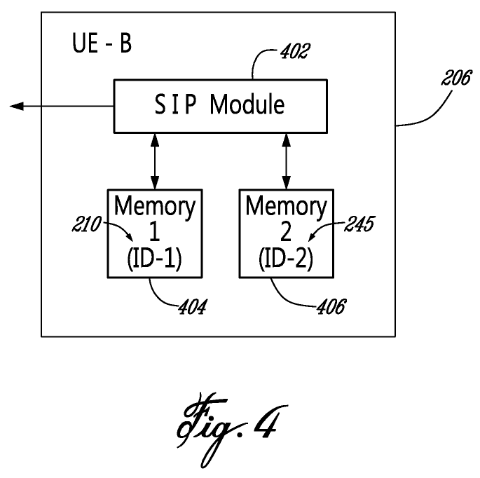

Reference is now made to FIG. 4 which shows a high level block diagram of an exemplary UE B 206. This UE is provided with a SIP module 402 responsible for handling incoming and outgoing SIP communications on behalf of the UE 206. Furthermore, the UE 206 is also provided with memories 404 and 406 for storing the first user identity 210 which can take the form of the original MSISN provided to the UE by the network 202, and second user identities 245 that can take the form of a second MSISDN and a SIP URI provided by the IMS network 204. With reference now being made jointly to FIG. 4, previously described, and to FIG. 3 that illustrates an exemplary flowchart diagram representative of a preferred embodiment of the present invention. In FIG. 3, in the step 302, the UE B has been assigned a first identity 210 in a first network (e.g. in network 202) for use, for example, with a first type of service (e.g. voice communications and SMS). For example, UE B 206 can be assigned the MSISDN 210 for use with basic services such as voice calls and SMS. In action 304, the UE B 206 registers with a second network, e.g. with the IMS network 204, and obtains a second identity in the second network for use with a second type of service. For example, the UE B 206 can register with the IMS network 204 and be assigned new credentials 245 in the form of a new MSISDN, and a new SIP URI to be used for the provision of IMS services, such as for example of Voice over IP, Video conferencing, instant message, chat, etc. In same action 304 the user's UE stores the new credentials 245 therein. In action 306, it is determined one or more users of the second network that need to be notified of the newly assigned second identity. Such a determination can be made based on users selected from the address book of user B 206, having for example the user B selecting one or more identities of the users to be notified, or alternatively using other procedures, for example notifying users of a given group, etc. In the exemplary description associated with FIG. 2, it was assumed that users A, C, and D were selected to be notified of the new second identity of the user B 206. In action 308, a notification is triggered or carried out towards the one or more users of the second network, the notification comprising, preferably, information containing both the first identity and the second identity assigned to the user, although it can be contemplated that it may comprise only the second identity. For example, the user B's UE 206 initiates the notification using the message 246 previously described in relation to FIG. 2 in order to notify user A, C, and D of his new identity 245. Steps 302, 304, 306, and 308 can be handled or, at least triggered, by the SIP module 402 of the UE B 206. Therefore, it becomes apparent that according to the present invention, a user can be assigned a new identity from another network and can then use the presence update mechanism in order to notify other users (e.g. a list of one or more contacts) of his new identity, so that the other users can use the new identity to initiate enhanced communications therewith. Once the IMS users are provided with the new identity of the user, they can store these credentials in their address books for example, in order to easily initiate subsequent communications.

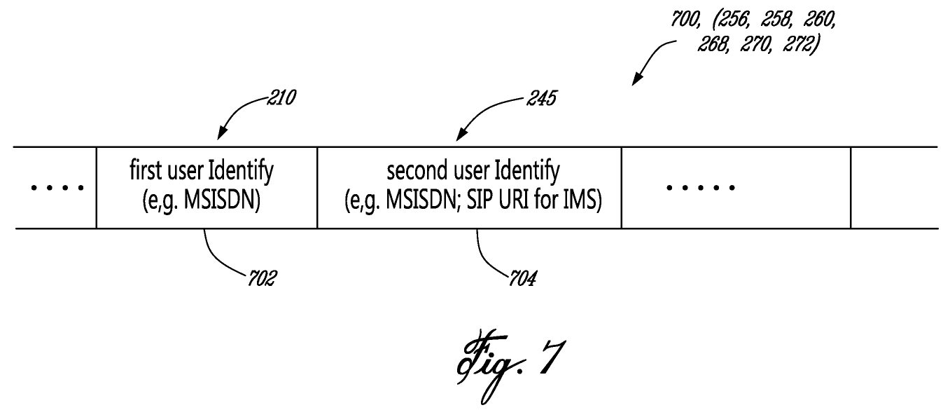

Reference is now made to FIG. 7, which shows a high-level diagram of a presence message according to the preferred embodiment of the invention. Shown in FIG. 7 is a presence message in the form of a computer data signal embodied in a transmission medium. The presence message 700 may comprise a first segment 702 including a first identity of a first UE, and a second segment including the second identity of the first UE. The presence message 700 is sent out to notify at least one second UE of the assignment of the second identity to the first UE. For example, with relation to the previously described Figures, the presence message 700 may include, or consist of, one of the SIP SUBSCRIBE messages 246, 256, 258, 260 or one of the SIP NOTIFY messages 268, 270, 272. The first segment 702 of the presence message 700 may include the first identity 210 (the MSISDN +1-514-333-3333) of the user B′ UE 206, as assigned by the network 202, while the second segment 704 may include the user's newly assigned credentials 245 (e.g. the IMS MSISDN and the SIP URI) as assigned by the network 204. According to this preferred embodiment of the invention, the presence message 700 has the form of a computer data signal embodied in a transmission medium, such as for example a radio signal sent over an air interface extending between the UE and a network, an electrical/digital signal sent over a wire line interface in the core network of networks 202 and/or 204, etc.

It is to be noted that the various modules and other components of the UE 206 and/or the presence server 226 can be implemented using various types of hardware and/or software modules. For example, it is contemplated that each such entity may comprise at least a processor that executes instructions, as well as various other combinations of hardware and/or software to enable the functioning of the methods described hereinbefore.

Based upon the foregoing, it should now be apparent to those of ordinary skills in the art that the present invention provides an advantageous solution, which offers a simple yet flexible and efficient manner of notifying users and contacts of a new identity being assigned to a given user. Although the system and method of the present invention have been described with particular reference to certain type of messages and nodes, it should be realized upon reference hereto that the innovative teachings contained herein are not necessarily limited thereto and may be implemented advantageously in various manners. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for notifying about a second user identity assignment to a User Equipment (UE) having already a first identity, the method comprising the steps of:
a. obtaining the second user identity from a network;
b. storing the second user identity in the UE; and
c. sending out a presence message to notify at least one other user about the second user identity, the presence message comprising the first and second identities of the UE.

2. The method claimed in claim 1, wherein the first user identity comprises an MSISDN (Mobile Station International Subscriber Directory Number) assigned to the UE by a first network, and the second user identity comprises an IMS (IP Multimedia) user identity assigned to the UE by an IMS network for use with IMS services.

3. The method claimed in claim 1, further comprising, prior to step c, the step of:
d. sending out an XCAP PUT message from the UE to an alert service, the XCAP PUT message comprising an indication of the at least one other user, and the first and second identities of the UE.

4. The method claimed in claim 1, wherein the presence message includes a SIP SUBSCRIBE message destined to the at least one user.

5. A User Equipment (UE) comprising:
a first memory storing a first identity of the UE;
a second memory adapted to store a second identity assigned to the UE; and
a SIP (Session Initiation Protocol) module that communicates with a network to obtain the second identity, wherein when the second identity is assigned to the UE it is stored in the second memory, and wherein the SIP module sends out a presence message to notify at least one other user about the second identity, the presence message comprising the first and second identities of the UE.

6. The UE claimed in claim 5, wherein the first user identity comprises an MSISDN (Mobile Station International Subscriber Directory Number) assigned to the UE by a first network, and the second identity comprises an IMS (IP Multimedia) identity assigned to the UE by an IMS network for use with IMS services.

7. The UE claimed in claim 5, wherein the SIP module is further adapted to send out an XCAP PUT message to an alert service, the XCAP PUT message comprising an indication of the at least one other user, and the first and second identities of the UE.

8. The UE claimed in claim 5, wherein the presence message includes a SIP SUBSCRIBE message destined to the at least one user.

9. A method for notifying about an assignment of a second identity to a first User Equipment (UE) having already a first identity, the method comprising the steps of:
a. receiving a presence message destined to a second UE, the message comprising the first identity of the first UE and the second identity of the first UE; and
b. responsive to the presence message, sending out a presence notification to the second UE, the presence notification comprising the first identity of the first UE and the second identity of the first UE.

10. The method claimed in claim 9, wherein the presence message comprises a SIP SUBSCRIBE message and the presence notification comprises a SIP NOTIFY message.

11. The method claimed in claim 9, wherein the first identity comprises an MSISDN (Mobile Station International Subscriber Directory Number) assigned to the first UE by a first network, and the second identity comprises an IMS (IP Multimedia) identity assigned to the UE by an IMS network for use with IMS services.

12. A presence server, comprising:
a presence service logic module comprising a SIP (Session Initiation Protocol) module that receives a presence message destined to a second UE, the message comprising a first identity of a first UE and a second identity of the first UE, and responsive to the presence message, the SIP module sending out a presence notification to the second UE, the presence notification comprising the first identity of the first UE and the second identity of the first UE.

13. The presence server claimed in claim 12, wherein the presence message comprises a SIP SUBSCRIBE message and the presence notification comprises a SIP NOTIFY message.

14. The presence server claimed in claim 12, wherein the first identity comprises an MSISDN (Mobile Station International Subscriber Directory Number) assigned to the first UE by a first network, and the second identity comprises an IMS (IP Multimedia) user identity assigned to the UE by an IMS network for use with IMS services.

15. A presence message in the form of a computer data signal embodied in a transmission medium, comprising:
a segment including a first identity of a first UE (User Equipment); and
another segment including a second identity of the first UE;
wherein the presence message is sent out to notify at least one second UE of an assignment of the second identity to the first UE.

16. The presence message in the form of the computer data signal embodied in the transmission medium claimed in claim 15, wherein the presence message is a SIP SUBSCRIBE message.

17. The presence message in the form of the computer data signal embodied in the transmission medium claimed in claim 15, wherein the presence message is a SIP NOTIFY message.

18. The presence message in the form of a computer data signal embodied in a transmission medium claimed in claim 15, wherein the first identity comprises an MSISDN (Mobile Station International Subscriber Directory Number) assigned to the first UE by a first network, and the second identity comprises an IMS (IP Multimedia) user identity assigned to the first UE by an IMS network for use with IMS services.
